(19) United States
(12) Patent Application Publication
(10) Pub. No.: US 2015/0310366 A1
(43) Pub. Date: Oct. 29, 2015

(54) Security region based security-constrained economic dispatching method

(71) Applicant: TIANJIN UNIVERSITY, Tianjin (CN)

(72) Inventors: Yixin YU, Tianjin (CN); Chao QIN, Tianjin (CN)

(73) Assignee: Tianjin University, Tianjin (CN)

(21) Appl. No.: 14/441,516

(22) PCT Filed: Nov. 8, 2013
(86) PCT No.: PCT/CN2013/086722

§ 371 Date: May 8, 2015

(30) Foreign Application Priority Data
Nov. 9, 2012 (CN) 201210448967.7

(51) Int. Cl. G06Q 10/06

(52) U.S. Cl. CPC G06Q 10/06312

(57) ABSTRACT

The present invention relates to a power system and provides a method for considering the network security constraints of in the operation of economic dispatch of power systems, which comprises the power flow constraint of branches, the static voltage stability constraint and the transient stability constraint, and provides an effective way for coordinating contradiction between the economy and security of power system operation. The security region based security-constrained economic dispatching method comprises the following steps: step 1, calculating the coefficients for the active power static security region, the cut-set voltage stability region and the dynamic security region respectively; step 2: building the models for security region based security-constrained economic dispatch; step 3: solving the unit on/off state optimal sub-problem through Social Evolutionary Programming; step 4: calculating the generation cost, the static voltage stability margin and the transient stability margin in the dispatching period; step 5: obtaining a feasible economic dispatching scheme, otherwise, return to step 3. The invention is mainly applied in load dispatching optimization.

### FIELD OF THE INVENTION

The present invention relates to power system, in particular to the security region based security-constrained economic dispatching method.

### BACKGROUND OF THE INVENTION

In modern power system, economic dispatch plays a key role in assuring the reliability of power supply and improving the economics of power system operation^{[1]}. The economic dispatch of power system can be divided into static economic dispatch and dynamic economic dispatch^{[2]}; for a certain dispatch time section, the static economic dispatch adjusts the activereactive power output of the units, the transformer tap, etc., to achieve the optimization goal, such as minimum cost and better power quality^{[3]}, such as Optimal Power Flow (short for OPF); in the dynamic economic dispatch, the dispatching period can be divided into several static time sections which are coupled with each other. By optimizing the on/off state of the units and dispatching the load to the running units, the dynamic economic dispatch is able to achieve the optimal goal in the whole dispatching period, such as the unit commitment^{[4]} (short for UC). In dynamic economic dispatch, the ramp rate and minimum continuous on/off time for units and the variability of load can be taken into account, so the achieved dispatching scheme is more reasonable.

In recent years, with the deregulation of power market, the integration of plenty of new equipment, rapid increase of load and integration of renewable energy, modern power system is faced with more and more complicated and uncertain factors. So it is necessary to consider the network security constraints in the economic dispatch which focuses on the economy of power system operation.

At present, researchers have made a lot of work on the transient stability constraints^{[5-8]} in the optimal power flow model field. According to the way of dealing with transient stability constraints, the methods fall into two types: method based on time-dominate simulation and method based on energy function^{[5]}. However, both of the types are of several drawbacks, such as large calculation burden, complex model and hard to solve. The reasons are in two aspects: the complexity for transient stability of power system, and the traditional analysis methods adopted in power system are ‘point-wise’ method (that is for a certain operating point, such as a point in the power injection space, the stability of power systems is judged through time domain simulation or energy function method), which is closely dependent on the system operation conditions, if the operation conditions are changed, recalculation is required. For the dynamic economic dispatch, i.e. the unit commitment problem, there are also several papers that have considered the security constraints^{[9]}; in reference[10], the transmission security and voltage constraints are considered in the unit commitment through the incorporation of optimal power flow; and reference [11] takes the dynamic stability constraint into account in the unit commitment for multi-area system. Up to now, there are no reports on consideration of static voltage stability and transient stability in the unit commitment problem at the same time. In conclusion, in the economic dispatch of power systems, it is hard to take the static stability constraint and the transient stability constraint into account and to evaluate the security margin of different dispatch schemes.

Reference [1]: A. J. Wood, B. F. Wollenberg. Power Generation Operation and Control, 1984, John Wiley, New York.

Reference [2]: W. G. Wood. Spinning reserve constrained static and dynamic economic dispatch[J]. IEEE Transactions on Power Apparatus and Systems, 1982, PAS-101(2): 381-388.

Reference [3]: M. Huneault, F. D. Galiana. A survey of the optimal power flow literature[J]. IEEE Transactions on Power System, 1991, 6(2): 762-770.

Reference [4]: R Baldick. The generalized unit commitment problem[J]. IEEE Transactions on Power Systems, 1995, 10(1): 465-475.

Reference [5]: Yuanzhang Sun, Xinlin Yang, Haifeng Wang. Optimal power flow with transient stability constraints in power systems[J]. Automation of Electric Power Systems, 2005, 29(16): 56-59.

Reference [6]: Mingbo Liu, Zeng Yang. Optimal power flow calculation with transient energy margin constraints under multi-contingency conditions[J]. Proceedings of the CSEE, 2007, 27(34): 12-18.

Reference [7]: Deqiang Gan, Robert J. Thomas, Ray D. Zimmerman. Stability constrained optimal power flow[J]. IEEE Transaction on Power System, 2000, 15(2): 535-540.

Reference [8]: Yue Yuan, Junji Kubokawa, Hiroshi Sasaki. A solution of optimal power flow with multi-contingency transient stability constraints[J]. IEEE Transactions on Power System, 2003, 18(3): 1094-1102.

Reference [9]: S. J. Wang, S. M. Shahidehpour, D. S. Kirschen, et. al. Short-term generation scheduling with transmission and environmental constraints using an augmented lagrangian relaxation[J]. IEEE Transactions on Power System, 1995, 10(3): 1294-1301.

Reference [10]: Haili Ma, S. M. Shahidehour. Unit commitment with transmission security and voltage constraints[J]. IEEE Transactions on Power System, 1999, 14(2): 757-764.

Reference [11]: Yuanyin Hsu, Chungching Su, Chihchien Liang etal. Dynamic security constrained multi-area unit commitment[J]. IEEE Transactions on Power Systems, 1991, 6(3): 1049-1055.

### SUMMARY OF THE INVENTION

The present invention is intended to overcome the shortcomings of prior art and provide an effective method in the operation of economic dispatch of power systems for solving the problems between the network security constraints (including the power flow constraint of branches, the static voltage stability and the transient stability constraint, etc.) and coordinating the economy and security aspects of power system operation, The technical solution of the invention relates to the security region based security-constrained economic dispatching method, which comprises the following steps:

Step 1: presetting unit parameter, network system topology parameter, cut-sets for the static voltage stability, contingency sets for the transient stability and power flow limit value for branches, calculating the coefficients for the active power steady security region, the cut-set voltage stability region and the dynamic security region;

Step 2: building the models for security region based security-constrained economic dispatch, which can be divided into the following models according to the optimization goals: (1) Model I, which takes the minimum total generation cost as its optimization goal, and the constraint conditions comprises the operating constraints of units, system power balance and spinning reserve constraints; (2) Model II, which takes the minimum total generation cost as its optimization goal, and the constraint conditions comprises the operating constraints of units, system power balance and spinning reserve constraints, and network security constraints; (3) Model III, which takes the maximum static voltage stability margin as its optimization goal, and the constraint conditions of which are same as that of Model II; (4) Model IV, taking the maximum transient stability margin as its optimization goal, and the constraint conditions of which are same as that of Model II; (5) Model V, which transforms the minimum total generation cost, the maximum static voltage stability margin and the maximum transient stability margin into a single optimization goal via the weighting method, and the constraint conditions of which are same as that of Model II. The model is divided into unit on/off state optimal sub-problem and load economic dispatching sub-problem to be solved.

Step 3: solving the unit on/off state optimal sub-problem through Social Evolutionary Programming (SEP), obtaining the optimal on/off states of unit for the dispatching period, calculating the start-up cost of units for the dispatch period, and achieving the actual upper and lower limit values for active power output for units with considering the ramp rate constraints of units.

Step 4: taking the on/off states and limit values for active power output of units as the input values, and solving the load economic dispatch sub-problem according to the optimization goal, i.e., optimal dispatching the active power output of units and calculating the generation cost, the static voltage stability margin and the transient stability margin of units;

Step 5: obtaining a feasible economic dispatching scheme through step 3 and step 4, and determining whether it satisfies the convergence condition: if yes, then stop; Otherwise, return to step 3.

The objective functions of models in the step 2 are introduced in detail as follows:

(1) variables definition

The variables used in the invention are defined as follows:

TC: Total generation cost of the system, including the start-up cost and generation cost of units;

T: time number of scheduling period;

G: Set of generator buses of the system;

Gₛ: Set of generators of the system, a generator bus may connects to sevaral units;

L: Set of load buses of the system;

B: Set of branches of the system;

N: Set of buses of the system, N=G∪L∪0, while 0 is the swing bus, the complex voltage of which is preset as the reference for the grid;

n: number of buses of the system; n=n_{G}+n_{L}+1

n_{g}: number of generators of the system;

n_{G}: number of generator buses of the system;

n_{L}: number of load buses of the system;

n_{L}: number of branches of the system;

wₜ: load weight of the period t;

w_{c}: cost weight of the period t;

wₛᵥ: Static voltage stability margin weight;

wₜₛ: transient stability margin weight;

Sᵢ(t): binary variable to indicate the state of unit i at period t; 0 represents the unit is off, while 1 represents on;

SCᵢ(t): start-up cost of unit i at period t;

Cᵢ(t): generation cost of unit i at period t;

C(t): total generation cost of the system at period t;

\tilde{C}(t): normalized value of the total generation cost of the system at period t;

P_{gi}(t): active power output of unit i at period t;

p_{gi}^{m}: minimum active power output of unit i;

p_{gi}^{M}: maximum active power output of unit i;

Pₗ^{M} : maximum active power flow of branch l allowed to transmit;

Xᵢ(t): Integer variable to indicate the cumulative operating state of unit i at period t; if Xᵢ(t)>0, it means that unit i is on before period t; otherwise, it means that unit i is off before period t;

Tᵢ^{off}: minimum continuous off-time of unit i;

Trᵢ^{on}: minimum continuous on-time of unit i;

Δpᵢ^{u}: maximum ramp-up ramp rate of unit i;

Δpᵢ^{d}: maximum shut-down ramp rate of unit i;

P_{gi}(t): active power output of bus i at period t;

P_{di}(t): active load of bus i at period t;

D(t): system total load at period t;

R(t): system allowed minimum spinning reserve capacity at period t;

Vᵢ: voltage amplitude of bus i;

θᵢ: voltage angle of bus i;

Gᵢⱼ: the conductance between bus i and bus j;

Bᵢⱼ: the susceptance between bus i and bus j;

Pₗ(t): active power flow of branch at period t;

CS: set of critical cut-sets for voltage stability, while CS(k) is Set of branches for cut-set k;

CTS: set of contingency for transient stability;

αᵢ^{k}: dynamic security region hyperplane coefficient of bus i for contingency k;

αₗ^{k}: cut-set voltage stability region hyperplane coefficient of branch for the cut-set k;

KD: matrix to indicate the cumulative operating states of units; if KD(t,i)>0, it means that unit i is on before period t; otherwise, it means that unit i is off before period t;

KJ: matrix to indicate on/off permission flags of units; KJ(t,i) represents on/off flag of unit i at period t, if KJ(t,i)=1, it means that unit i can be turned on at period t; if KJ(t,i)=−1, it means that unit i can be turned off at period t; if KJ(t,i)=0, it means that unit i must keep its operating state;

KR: matrix to indicate operating states of units; if KR(t,i)=1, it means that unit i is on at period t; if KR(t,i)=0, it means that unit i is off at period t;

(2) Objective Function

(2.1) Model I & II

The objective of Model I and II is minimization of total cost, which consists of two parts: the generation cost and the start-up cost. The objective function is shown in equation (1).

$$min TC = {\sum }_{t = 1}^{T} {\sum }_{i = 1}^{{n}_{g}} {S}_{i} ( t ) ( 1 - {S}_{i} ( t - 1 ) ) {SC}_{i} ( t ) + {\sum }_{t = 1}^{T} {\sum }_{i = 1}^{{n}_{g}} {S}_{i} ( t ) {C}_{i} ( t ) \qquad ( 1 )$$

Wherein, the start-up costs of the i^{th} unit is the function of its off-time as shown in equation (2), and the generation costs of the i^{th} unit can be approximated by a quadratic function, which is shown in equation (3). αᵢ, βᵢ and τᵢ are the coefficients of the start-up cost for i^{th} unit, αᵢ, βᵢ and cᵢ are the coefficients of the generation cost for the i^{th} unit, p_{gi}(t)is the active power output of the i^{th} unit i.

SCᵢ(t)=αᵢ, +βᵢ(1−exp(Xᵢ(t)/τᵢ)) (2)

Cᵢ(t)=aᵢp_{gi}²(t)+bᵢp_{gi}(t)+cᵢ (3)

With the same objective function, the difference between Model I and Model II is: through the hyper-plane descriptive approach for security region, Model II designs the power flow constraint of branches, the static voltage stability constraint and the transient stability constraint on the basis of Model I.

(2.2) Model III

Model III is oriented to maximize the static voltage stability margin of power system and takes the operating constraints of units, the system power balance and spinning reserve constraints and the network security constraints into consideration for dispatching the system. The static voltage stability margin is defined as the distance from the current operating point and the boundary of CVSR, which is shown in equation (4). As there exists more than one critical cut-set for the static voltage stability, the minimum distance from the operating point to the boundaries of CVSR for all critical cut-sets is taken as the static voltage stability margin, shown in equation (5); wherein, ηₛᵥ^{k}(t) is the distance from the current operating point to the corresponding cut-set voltage boundary of the k^{th} critical cut-set at period t, and can be used as the approximate description of the static voltage stability margin of the current operating point for the k^{th} critical cut-set.

$$\begin{matrix}{η}_{sv} ( t ) = 1 - {\sum }_{l ∈ CS} {α}_{l} {P}_{l} ( t ) & ( 4 ) \\ {η}_{sv} ( t ) {min}_{k} {η}_{sv}^{k} ( t ) = {min}_{k} ( 1 - {\sum }_{l ∈ CS ( k )} {α}_{l}^{k} {P}_{l} ( t ) ) & ( 5 )\end{matrix}$$

For the whole dispatching horizon, static voltage stability margins of different periods are multiplied by the load-level weight, and forming the objective function as shown in equation (6):

$$\begin{matrix}max {η}_{sv} = max min {\sum }_{t = 1}^{T} {w}_{t} {η}_{sv}^{k} ( t ) & ( 6 ) \\ {w}_{t} = D ( t ) / {\sum }_{t = 1}^{T} D ( t ) & ( 7 )\end{matrix}$$

(2.3) Model IV

The transient stability margin is defined as the distance from the current operating point to the boundary of dynamic security region, as shown in equation (8).

$${η}_{ts} ( t ) = 1 - {\sum }_{i ∈ G ⋃ L} {α}_{i} {P}_{i} ( t ) \qquad ( 8 )$$

Assuming that the predictive contingency comprising more than one fault, the minimum distance from the current operating point to the boundaries of dynamic security region for all faults is taken as the transient stability margin, as shown in equation (9). Wherein, ηₜₛ^{k}(t) is the distance from the current operating point to the boundary of dynamic security region for the k^{th} contingency, and can be used as the approximate description of the transient stability margin of the current operating point for the k^{th} contingency.

$${η}_{ts} ( t ) = {min}_{k ∈ CTS} {η}_{ts}^{k} ( t ) = {min}_{k ∈ CTS} ( 1 - {\sum }_{i ∈ G ⋃ L} {α}_{i}^{k} {P}_{i} ( t ) ) \qquad ( 9 )$$

Similar to Model III, for the whole dispatching horizon, transient stability margins of different periods are multiplied by the load-level weights, forming the objective function (10) of Model IV:

$$max {η}_{ts} = max min {\sum }_{t = 1}^{T} {w}_{t} {η}_{ts}^{k} ( t ) \qquad ( 10 )$$

(2.4) Model V

For solving the incommensurability, the normalization of objective function is adopted as shown in equation (11), and the evaluation function method is also adopted for transforming the multi-objective programming problem into a single objective programming problem, wherein the equation (11):

$$\tilde{C} ( t ) = 2 - \frac{C ( t )}{{C}_{0} ( t )} \qquad ( 11 )$$

Through the normalization, the value of normalized value ranges from 0 to 1. And through the weighting method, Model V can be transformed into a single-objective optimization problem as shown in equation (12):

$$max ϕ = max {\sum }_{t = 1}^{T} {w}_{t} ( {w}_{c} \tilde{C} ( t ) + {w}_{sv} {η}_{sv} ( t ) + {w}_{ts} {η}_{ts} ( t ) ) \qquad ( 12 )$$

(3) Constraints

The constraints in the present invention comprises: the operating constraints of units, the system constraints (including power balance constraint and spinning reserve constraint) and the network security constraints.

(3.1) Operating Constraints of Units

The operating constraints of units include the active power output constraint, the minimum continuous on/off time constraint and the ramp rate constraint, wherein:

Active power output constraint:

p_{gi}^{m}≦p_{gi}(t)≦p_{gi}^{M} (13)

Ramp rate constraint:

−Δpᵢ^{d}≦p_{gi}(t)−_{gi}(t−1)≦Δpᵢ^{u} (14)

Minimum continuous on/off time constraint:

$$\{ \begin{matrix}if {S}_{i} ( t ) - {S}_{i} ( t - 1 ) = 1 then - {X}_{i} ( t ) \geq {T}_{i}^{off} \\ if {S}_{i} ( t ) - {S}_{i} ( t - 1 ) = - 1 then {X}_{i} ( t ) \geq {T}_{i}^{on}\end{matrix} \qquad ( 15 )$$

(3.2) Power Balance and Spinning Reserve Constraints

The system constraints include the power balance constraint and spinning reserve constraint, wherein:

Power balance constraint:

$${\sum }_{i = 1}^{{n}_{g}} {S}_{i} ( t ) {p}_{gi} ( t ) = D ( t ) \qquad ( 16 )$$

Spinning reserve constraint:

$${\sum }_{i = 1}^{{n}_{g}} {S}_{i} ( t ) {p}_{gi}^{M} \geq D ( t ) + R ( t ) \qquad ( 17 )$$

(3.3) Network Security Constraints

The network security constraints include the branch power flow constraint, the static voltage stability constraint and the transient stability constraint, wherein:

Branches power flow constraint

−Pₗ^{M}≦Pₗ(t)≦Pₗ^{M} l∈B (18)

Static voltage stability constraint

$${\sum }_{∀ l ∈ CS ( k )} {α}_{l}^{k} {P}_{l} ( t ) \leq 1 , k ∈ CS \qquad ( 19 )$$

Transient stability constraint

$${\sum }_{∀ i ∈ G ⋃ L} {α}_{i}^{k} {P}_{i} ( t ) \leq 1 , k ∈ CTS \qquad ( 20 )$$

The Technical Characteristics and the Effects

The security-constrained economic dispatching method of the invention comprehensively considers the operating constraints of units, the system constraints and the network security constraints including the branch power flow constraint, the static voltage stability constraint and the transient stability constraint, designs the dispatching scheme more scientific and reasonable, and also defines the security margin of dispatching schemes and provides a useful method for power dispatcher to balance the economy and security of power system operation.

Specifically, the invention realizes:

(1) The consideration of the branch power flow constraint through active power steady security region.

(2) The consideration of the static voltage stability constraint and the definition of the static voltage stability margin via cut-set static voltage stability region, taking the static voltage stability margin as the optimization goal of power system dispatch.

(3) The consideration of the transient stability constraint and the definition of the transient stability margin via dynamic security region, taking the transient stability margin as the optimization goal of power system dispatch.

(4) The multi-objective model with consideration of both the economy and the security of power systems, which evaluates the economy of power systems through the total costs and the security of power systems through the distance from the current operating point to the boundary of security region to deal with the contradiction between the economy aspect and the security aspect of power systems.

(5) The security region based security-constrained economic dispatch model is divided into two sub-problems, i.e. the unit on/off State schedule sub-problem and the load economic dispatch sub-problem. And the first sub-problem is solved by social evolutionary programming method, while the second sub-problem is transformed into quadratic programming problem or multi-objective problem.

### BRIEF DESCRIPTION OF THE DRAWINGS

FIG. 1 is a frame diagram of model in the present invention;

FIG. 2 is a schematic diagram of normalization of generation cost;

FIG. 3 is a frame diagram of solution method;

FIG. 4 is a schematic diagram of cognitive process of SEP;

FIG. 5 is a schematic diagram of IEEE RTS-24;

FIG. 6 is the load curve of the power system;

FIG. 7 is a diagram showing the on/off states for units (Model I);

FIG. 8 is a diagram of active power output of units (Model I);

FIG. 9 is a diagram of active power flow of heavy-duty branches (Model I);

FIG. 10 is a diagram of validation of the static voltage stability constraint (Model I);

FIG. 11 is a diagram of validation of the transient stability constraint (Model I);

FIG. 12 is a diagram of the transient stability simulation results (Model I);

FIG. 13 is a diagram showing the on/off state of units (Model II);

FIG. 14 is a diagram of active power output of units (Model II);

FIG. 15 is a diagram of active power flow of heavy-duty branches (Model II);

FIG. 16 is a diagram of validation of the static voltage stability constraint (Model II);

FIG. 17 is a diagram of validation of the transient stability constraint (Model II);

FIG. 18 is a diagram of the transient stability simulation results (Model II);

FIG. 19 is a diagram showing the difference of active power output;

FIG. 20 is a diagram showing sensitivities of transient stability margin to active power output;

FIG. 21 is a diagram of comparison of the Static voltage stability margin for Model II and Model III;

FIG. 22 is a diagram of the transient stability for dispatch schemes of Model IV;

FIG. 23 is a diagram of comparison of dispatching schemes;

FIG. 24 is a diagram showing the influence of weights.

### DETAILED DESCRIPTION OF THE INVENTION

To solve the problems that is hard to take the static voltage stability constraint and the transient stability constraint into consideration and to evaluate the security margin of dispatch schemes in the economic dispatch of power systems, based on the security region methodology, the invention comprehensively considers the branches power flow constraint, the static voltage stability constraint and the transient stability constraint through the active power steady security region, the cut-set voltage stability region and the dynamic security region. According to the distance from the current operating point to the boundary of security region, the invention defines the static voltage stability margin and the transient stability margin and builds models that take the security margin as its optimization goal and a multi-objective model that consider both the economy and security aspects of power systems. The security region based security-constrained economic dispatching model is divided into two sub-problems, i.e. the unit on/off state schedule sub-problem and the load economic dispatch sub-problem. And the first sub-problem is solved by social evolutionary programming method, while the second sub-problem is transformed into quadratic programming problem or multi-objective problem. The models presented in the invention provide a useful tool for power dispatchers to consider complicated security constraints and to deal with the economy and the security aspects of power system operation, and make the dispatch schemes more scientific and reasonable.

In the security region based security-constrained economic dispatch model presented in the invention, the optimization goals comprises: the minimum total generation cost, the maximum static voltage stability margin and the maximum transient stability margin; the constraints comprises: operating constraints of units, the power balance and spinning reserve constraints and the network security constraints. The specific technical solutions are:

Step 1: presetting unit parameter, network system topology parameter, cut-sets for the static voltage stability, contingency sets for the transient stability and power flow limit value for branches, calculating the coefficients for the active power static security region, the cut-set voltage stability region and the dynamic security region;

Step 2: building the models for security region based security-constrained economic dispatch, which can be divided into the following models according to the optimization goals: (1) Model I, which takes the minimum total generation cost as its optimization goal, and the constraint conditions comprises the operating constraints of units, system power balance and spinning reserve constraints; (2) Model II, which takes the minimum total generation cost as its optimization goal, and the constraint conditions comprises the operating constraints of units, system power balance and spinning reserve constraints, and network security constraints; (3) Model III, which takes the maximum static voltage stability margin as its optimization goal, and the constraint conditions of which are same as that of Model II; (4) Model IV, taking the maximum transient stability margin as its optimization goal, and the constraint conditions of which are same as that of Model II; (5) Model V, which transforms the minimum total generation cost, the maximum static voltage stability margin and the maximum transient stability margin into a single optimization goal via the weighting method, and the constraint conditions of which are same as that of Model II. The model can be divided into unit on/off state optimal sub-problem and load economic dispatching sub-problem to be solved.

Step 3: solving the unit on/off state optimal sub-problem through Social Evolutionary Programming (SEP), obtainging the optimal on/off states of unit for the dispatching period, calculating the start-up cost of units for the dispatch period, and achieving the actual upper and lower limit values for active power output for units with considering the ramp rate constraints of units.

Step 4: taking the on/off states and limit values for active power output of units as the input values, and solving the load economic dispatch sub-problem according to the optimization goal, i.e., optimal dispatching the active power output of units and calculating the generation cost, static voltage stability margin and the transient stability margin of units;

Step 5: obtaining a feasible economic dispatching scheme through step 3 and step 4, and determining whether it satisfies the convergence condition: if yes, then stop; Otherwise, return to step 3.

The present invention will be described in detail in combination with the accompanying drawings and embodiments.

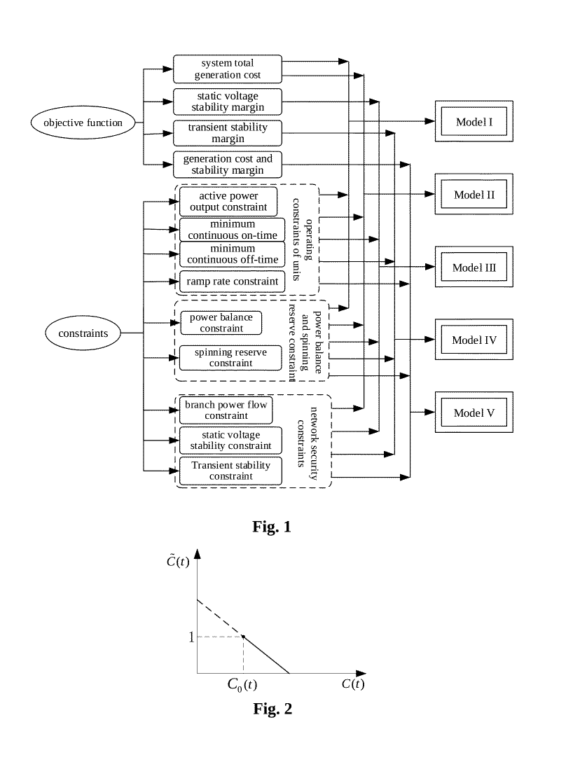

The security region based security-constrained economic dispatching method of the invention takes the minimum total generation cost, the maximum static voltage stability margin and the maximum transient stability margin as its objective function and considers the operating constraints of units, the power balance and spinning reserve constraints and the network security constraints. The frame diagram of the model is shown in FIG. 1.

(1) The security region based security-constrained economic dispatching model

(a) Objective Function

Model I&II

The objective of Model I and II is minimization of total generation cost, which consists of two parts: the generation cost and the start-up cost. The objective function is shown in equation (21).

$$min TC = {\sum }_{t = 1}^{T} {\sum }_{i = 1}^{{n}_{g}} {S}_{i} ( t ) ( 1 - {S}_{i} ( t - 1 ) ) {SC}_{i} ( t ) + {\sum }_{t = 1}^{T} {\sum }_{i = 1}^{{n}_{g}} {S}_{i} ( t ) {C}_{i} ( t ) \qquad ( 21 )$$

Wherein, the start-up costs of units i is the function of the off-time of units as shown in equation (22), and the generation costs of units i can be approximated by a quadratic function, which is shown in equation (23)

SCᵢ(t)=αᵢ+βᵢ(1−exp(Xᵢ(t)/τᵢ)) (22)

Cᵢ(t)=αᵢp_{gi}²(t)+bᵢp_{gi}(t)+cᵢ (23)

With the same objective function, the difference between Model I and Model II is: through the hyper-plane descriptive approach for security region, Model II designs the power flow constraint of branches, the static voltage stability constraint and the transient stability constraint on the basis of Model I.

Model III

Model I and II take the economy of power system operation as the optimization goal, which deal the static voltage stability constraint as a hard constraint and not consider the differences of the static voltage stability margin under different dispatching schemes. Model III takes the static voltage stability margin as its optimization goal, and considers the operating constraints of units, the power balance and spinning reserve constraints and the network security constraints.

The static voltage stability margin is defined as the distance from the current operating point to the boundary of CVSR, which is shown in equation (24). As there exists more than one critical cut-set for the static voltage stability, the minimum distance from the operating point to the boundaries of CVSR for all critical cut-sets is taken as the static voltage stability margin, as shown in equation (25). Wherein, ηₛᵥ^{k}(t) is the distance from the current operating point to the boundary of the k^{th} critical cut-set at period t, and can be used as the approximate description of the static voltage stability margin of the current operating point for the k^{th} critical cut-set.

$$\begin{matrix}{η}_{sv} ( t ) = 1 - {\sum }_{l ∈ CS} {α}_{l} {P}_{l} ( t ) & ( 22 ) \\ {η}_{sv} ( t ) = {min}_{k} {η}_{sv}^{k} ( t ) = {min}_{k} ( 1 - {\sum }_{l ∈ CS ( k )} {α}_{l}^{k} {P}_{l} ( t ) ) & ( 23 )\end{matrix}$$

For the whole dispatching horizon, static voltage stability margins of different periods are multiplied by the load-level weight, and forming the objective function as shown in equation (26). The load-level weight is calculated through (27).

$$\begin{matrix}max {η}_{sv} = max min {\sum }_{t = 1}^{T} {w}_{t} {η}_{sv}^{k} ( t ) & ( 24 ) \\ {w}_{t} = D ( t ) / {\sum }_{t = 1}^{T} D ( t ) & ( 25 )\end{matrix}$$

Model IV

Similar to Model III, Model IV takes the transient stability margin as its optimization goal and considers the operating constraints of units, the power balance and spinning reserve constraints and the network security constraints. The transient stability margin is defined as the distance from the current operating point to the boundary of DSR, as shown in equation (28).

$${η}_{ts} ( t ) = 1 - {\sum }_{i ∈ G ⋃ L} {α}_{i} {P}_{i} ( t ) \qquad ( 26 )$$

Assuming that the predictive contingency comprising more than one fault, the minimum distance from the current operating point to the boundaries of DSR for all faults is taken as the transient stability margin, shown in equation (29). ηₜₛ^{k}(t) is the distance from the current operating point to the boundary of dynamic security region for the k^{th} contingency, and can be used as the approximate description of the transient stability margin of the current operating point for the k^{th} contingency.

$${η}_{ts} ( t ) = {min}_{k ∈ CTS} {η}_{ts}^{k} ( t ) = {min}_{k ∈ CTS} ( 1 - {\sum }_{i ∈ G ⋃ L} {α}_{i}^{k} {P}_{i} ( t ) ) \qquad ( 27 )$$

Similar to Model III, for the whole dispatching horizon, transient stability margins of different periods are multiplied by the load-level weights, forming the objective function (30) of Model IV:

$$max {η}_{ts} = max min {\sum }_{t = 1}^{T} {w}_{t} {η}_{ts}^{k} ( t ) \qquad ( 28 )$$

Model V

Model I, II, III and IV are all single-objective optimization problems, and Model I and II focus on the economics of power system, while Model III and IV focus on the security aspect of power system. In practice, the power system dispatchers have to balance the economics and security aspects of power system, Model V comes into being for the problem. It takes the minimization of total cost, the maximization of static voltage stability margin and the maximization of transient stability margin as the objectives, comprehensively considers the economics and security of power system operation, therefore it is a typical multiple-objective optimization problem. The economics is represented by the total generation cost, while the security aspect is dealt with the static voltage stability margin and the transient stability margin, both of which are of incommensurability and contradiction. To solving the incommensurability, the normalization of objectives is adopted, as shown in equation (31).

$$\tilde{C} ( t ) = 2 - \frac{C ( t )}{{C}_{0} ( t )} \qquad ( 29 )$$

Through the normalization of generation cost, the range of its values is shown in FIG. 2, and the lower the total cost is, the value is approximate to 1. The value of normalized cost in Model V ranges from 0 to 1, which satisfies commensurability. And through the weighting method, Model V can be transformed into a single-objective optimization problem as shown in equation (32):

$$max ϕ = max {\sum }_{t = 1}^{T} {w}_{t} ( {w}_{c} \tilde{C} ( t ) + {w}_{sv} {η}_{sv} ( t ) + {w}_{ts} {η}_{ts} ( t ) ) \qquad ( 30 )$$

(b) Constraints

The constraints in the present invention comprises: the operating constraints of units, the power balance and spinning reserve constraints and the network security constraints.

Operating Constraints of Units

The operating constraints of units include the active power output constraint, the minimum continuous on/off time constraint and the ramp rate constraint:

Active power output constraint

p_{gi}^{m}≦p_{gi}(t)≦p_{gi}^{M} (31)

Ramp rate constraint

−Δpᵢ^{d}≦p_{gi}(t)−p_{gi}(t−1)≦Δpᵢ^{u} (32)

Minimum continuous on/off time constraint

$$\{ \begin{matrix}if {S}_{i} ( t ) - {S}_{i} ( t - 1 ) = 1 & then - {X}_{i} ( t ) \geq {T}_{i}^{off} \\ if {S}_{i} ( t ) - {S}_{i} ( t - 1 ) = - 1 & then {X}_{i} ( t ) \geq {T}_{i}^{on}\end{matrix} \qquad ( 33 )$$

The power balance constraint means that the total active power output of units must be equal to the load when neglecting grid loss, and enough spinning reserve capacity is required.

Power balance constraint

$${\sum }_{i = 1}^{{n}_{g}} {S}_{i} ( t ) {p}_{gi} ( t ) = D ( t ) \qquad ( 34 )$$

Spinning reserve constraint

$${\sum }_{i = 1}^{{n}_{g}} {S}_{i} ( t ) {p}_{gi}^{M} \geq D ( t ) + R ( t ) \qquad ( 35 )$$

The network security constraints include the branch power flow constraint, the static voltage stability constraint and the transient stability constraint.

Branch power flow constraint

−Pᵢ^{M}≦Pₗ(t)≦Pₗ^{M} l∈B (36)

Static voltage stability constraint

$${\sum }_{∀ l ∈ CS ( k )} {α}_{l}^{k} {P}_{l} ( t ) \leq 1 , k ∈ CS \qquad ( 37 )$$

Transient stability constraint

$${\sum }_{∀ i ∈ G ⋃ L} {α}_{i}^{k} {P}_{i} ( t ) \leq 1 , k ∈ CTS \qquad ( 38 )$$

(2) Solution Method

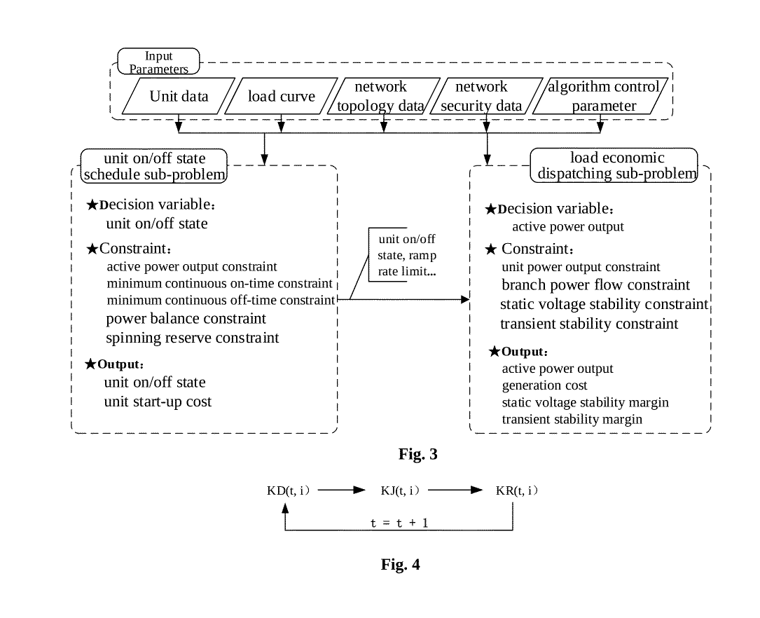

The model presented in the invention is a complex Nonlinear Mixed-Integer Programming problem, and it is decomposed into two sub-problems: the unit on/off state schedule sub-problem with integer variables and the load economic dispatch sub-problem with continuous variables. The first sub-problem is 0-1 programming problem and is solved through the Social Evolutionary Programming method. The second sub-problem can be converted into a Quadratic Programming Model, Max-Min Programming Model or Multiple-objectives Programming Model according to the different objective functions. The operation states of units under different periods are coupled with each other via minimum continuous on/off time constraint, and the power output of units under different periods are also constrained by the ramp rate limit, therefore, compared to the traditional optimal power flow, security-constrained economic dispatch is kind of rolling optimization strategy. The load economic dispatch sub-problems of different time sections are coupled with each other, and how to deal with the corresponding constraints has an important effects on the solving speed and convergence of the sub-problems. The framework of solution method is shown in FIG. 3.

(a) Unit On/Off State Schedule Sub-Problem

The Unit on/off State Schedule Sub-problem is solved through the Social Evolutionary Programming (hereinafter referred to as SEP) method. The basic idea of SEP is: to the UC problem, several cognitive rules are defined to guide the agents to study and update with each other, which can avoid a lot of non-feasible solutions against the minimum continuous on/off time limits of units. The SEP constitutes of several smart agents of simple cognitive abilities (inference, decision-making and so on); and the mechanism of crossover and mutation in traditional intelligent algorithms is replaced with the mechanism of “paradigm study and update”.

The cognitive process is shown in FIG. 4. During the process of determining KJ(t,i) through KD(t,i), prospective time window is adopted to assess the influence of turning off a unit. Usually, the length of time window is set as the minimum continuous off-time.

The optimization process of cognitive agents comprises:

\textcircled{1} Inputting the base data for UC, and sorting all the units according to the average cost of maximum active power output hrᵢ=aᵢp_{gi}^{M}+bᵢ+cᵢ/p_{gi}^{M} in ascending order;

\textcircled{2} According to KD(t, i), judging whether units satisfy the minimum continuous on/off time constraint and determining KJ(t,i) (i=1, 2, . . . , N);

\textcircled{3} Selecting one or several units in the set of units which satisfies KJ(t,i)≠0,i=1,2, . . . N and can change the state of those units, thus forming a new dispatch scheme, then judging whether the new dispatch scheme satisfies the load and spinning reserve constraints, if yes, then go to step \textcircled{4}, otherwise repeat \textcircled{3}; when selecting the units to be turned on, the units with lower hr are of priority and the units with higher hr are more likely to be turned off;

\textcircled{4} achieving KR(t,i), (i=1, 2, . . . , N);

\textcircled{5} if t=T, stopping; if t<T, determining KR(t+1, i) according to KR(t, i), and return \textcircled{2}.

The rules for agents to inherit and update a paradigm are as follows: For the dispatching period t, the agent selects a paradigm Dₛ^{k} through Roulette Selection Method; Ωₖₒₙ^{t} is the set of units that can be turned on at period t in Dₛ^{k} while Ω_{koff}^{t} is the set of units that can be turned off. And Ω_{con}^{t} is the set of units that can be turned on at period t for the present solution while Ω_{coff}^{t} is the set of units that can be turned off. When determining KR (t,i) known, the agent will select units of a lower hr (hrᵢ=aᵢp_{gi}^{M}+bᵢp_{gi}^{M}+cᵢ/p_{gi}^{M}) in Ω_{con}^{t} ∩Ωₖₒₙ ^{t} to turn on and units of a higher hr in Ω_{coff}^{t} ∩Ω_{koff}^{t} to turn off; if Ω_{con}^{t}∩Ωₖₒₙ^{t}=φ or Ω_{coff}^{t}∩Ω_{koff}^{t}=φ (φ is null set), the agent will random select units in Ω_{con}^{t} or Ω_{coff} ^{t} to transform their states. And other units will remain their operating states.

(b) Load Economic Dispatch Sub-Problem

There are a few assumptions for solving the load economic dispatching sub-problem:

1) For the transmission system of high voltage, the impedance of transmission lines are far more than the resistance, so it is assumed that Gᵢⱼ>>0, neglecting conductance of transmission line;

2) Under the steady-state operating conditions, the branch angle qᵢⱼ is very small, so there exists such approximation relation of sin θᵢⱼ≈θᵢⱼ; cos θᵢⱼ≈1;

3) As the economic dispatch of active power is concerned in power system, assuming V,ᵢ>>1, neglecting the influence of reactive power.

Under the above assumptions, the power flow function of power system can be transformed into

$${P}_{gi} ( t ) - {P}_{di} ( t ) = {\sum }_{j ∈ i} {B}_{ij} {θ}_{ij} ( t ) i ∈ N \qquad ( 39 )$$

Further, (41) can be expressed as θₗ(t)=XP(t), wherein X=B⁻¹=[x₀, x₁, . . . , xₙ]^{T}.

$$\begin{matrix}{P}_{l} ( t ) = {P}_{ij} ( t ) \\ = \frac{{V}_{i} {V}_{j}}{{x}_{ij}} sin {θ}_{ij} ( t ) \\ \approx \frac{{θ}_{ij} ( t )}{{x}_{ij}} \\ = {K}_{l}^{T} P ( t )\end{matrix} \qquad ( 40 )$$

Wherein, Kₗ^{T}=−Bᵢⱼ(xᵢ−xⱼ)

So the static voltage stability constraint can be transformed into the bus power injection space, shown in equation (43).

$${\sum }_{∀ l ∈ CS ( k )} {α}_{l}^{k} {K}_{l}^{T} P ( t ) \leq 1 , k ∈ CS \qquad ( 41 )$$

To assure the spinning reserve constraint for next period, a constraint shown in equation (44) is considered in the second sub-problem:

$${\sum }_{i = 1}^{{n}_{g}} min ( {p}_{gi} ( t ) + Δ {p}_{i}^{u} , {p}_{gi}^{M} ) \geq D ( t + 1 ) + R ( t + 1 ) \qquad ( 42 )$$

According to the different objective functions, the Load Economic Dispatch Sub-problem may be transformed as a Quadratic Programming Model (Model I & II), Max-Min Programming Model (Model III & IV) or Multiple-objectives Programming Model (Model V).

(3) Case Study

The IEEE RTS 24 case is adopted to introduce the model and solution method presented in the invention.

(a) Introduction of the Case

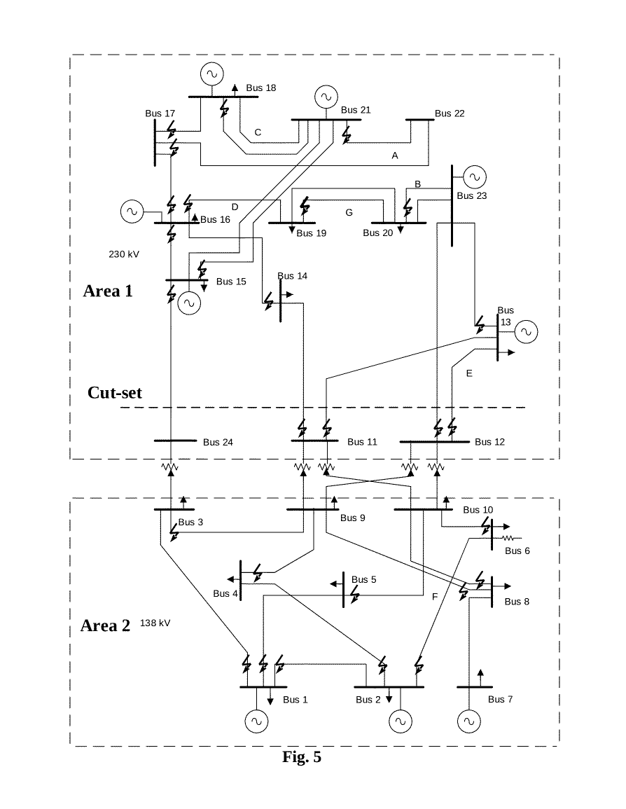

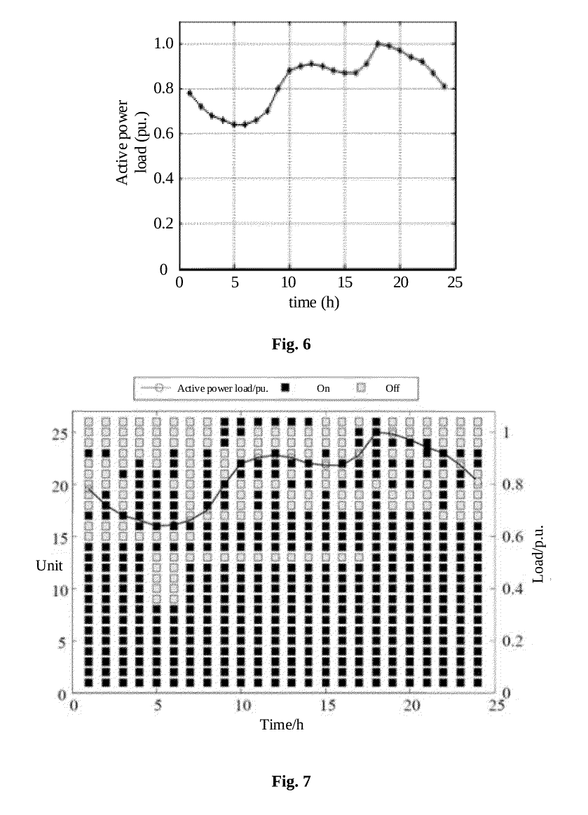

The diagram of the IEEE RTS 24 system is shown in FIG. 5. The total installed capacity of IEEE RTS-24 system is 3104MW and comprises 26 units, 2 of which are nuclear power plant (U400×2), 9 of which are fuel thermal power plant (U350, U155×4, U76×4), and 15 of which are oil thermal power plant (U197×3, U100×3, U20×4, U12×5), shown in Table I. The detail parameters of units used for the calculation of SR are given in reference [21]. The system comprises 24 buses, 33 transmission lines and 5 transformers; the voltage level is 138/230 kV, and can be divided into two areas of the high-voltage area and the low-voltage area. The load curve is shown in FIG. 6.

(b) Calculation Conditions

The transmission line capacity limits of all transmission lines and transformers are considered, and the limit parameters can refer to reference [9]. The critical cut-set for static voltage stability consists of 5 transmission lines, which are L15-24, L11-14, L11-13, L12-23, L12-13. The contingency set of transient stability is made up of 28 three-phase short circuit faults at the header point of transmission lines. Once the line L7-8 is cut down, the system will be divided into two parts, therefore, the fault of this line is not considered in the contingency.

(c) Results

On the calculation conditions, the results of IEEE RTS 24 are shown as follows.

Model I

On/off state and active power output of units

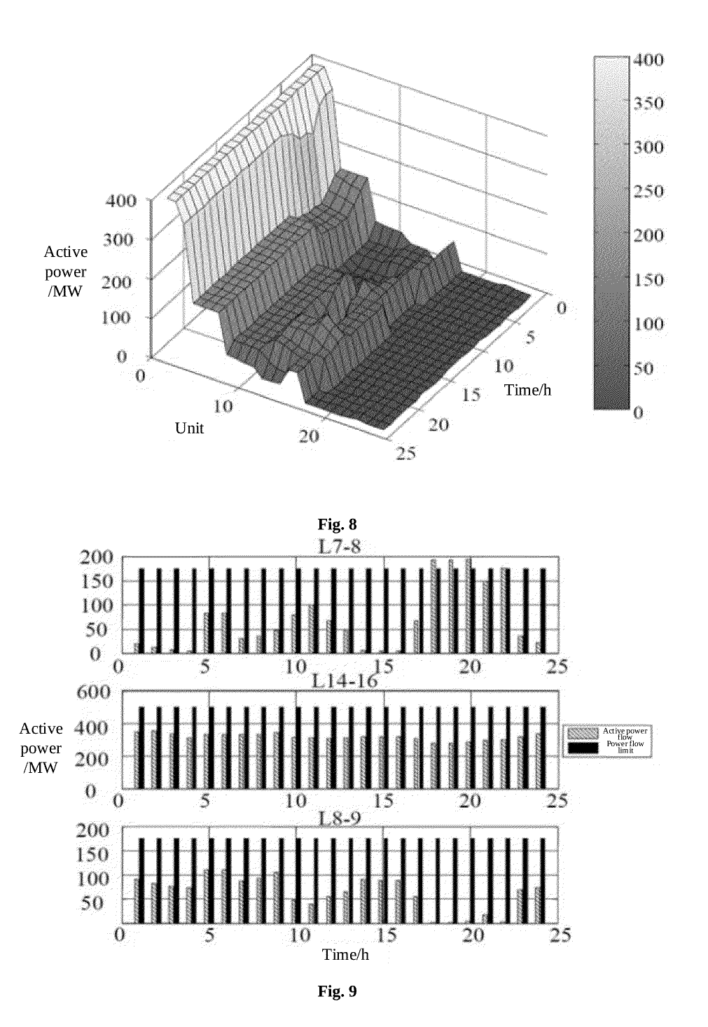

The optimal on/off state of units acquired by Model I is shown in FIG. 7, and active power output of units is shown in FIG. 8.

As shown in FIG. 7 and FIG. 8, the units of U400, U350 and U155 are of large capacity, low average generation cost, and large minimum continuous on/off time, so in the whole dispatch period, these units keep full-load running to guarantee the economics of power system during operation. The units of U197, U100 and U76 take on the middle part of load curve. The units of U20 and U12 are of small capacity and low start-up cost, flexible to change operating states, so these units take on the peak load.

The Adaptation of Optimal Solution to Network Constraints

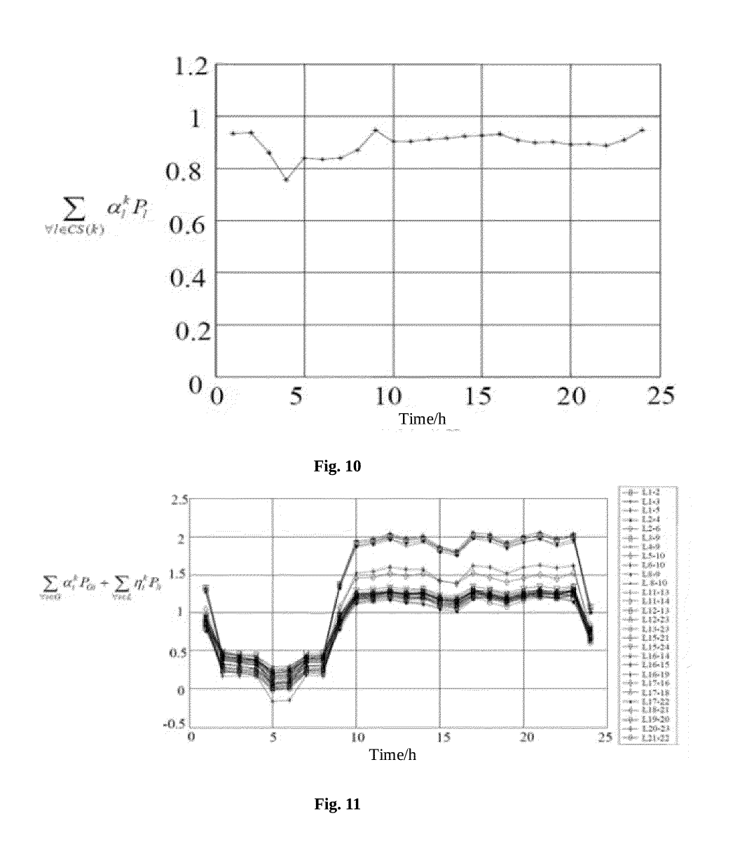

As Model I, i.e. the traditional model of unit commitment, only focuses on the economy aspect of power system, and does not consider the network constraints. Operating network security constraints to the economic dispatching method of Model I, the results are shown in FIGS. 9, 10 and 11.

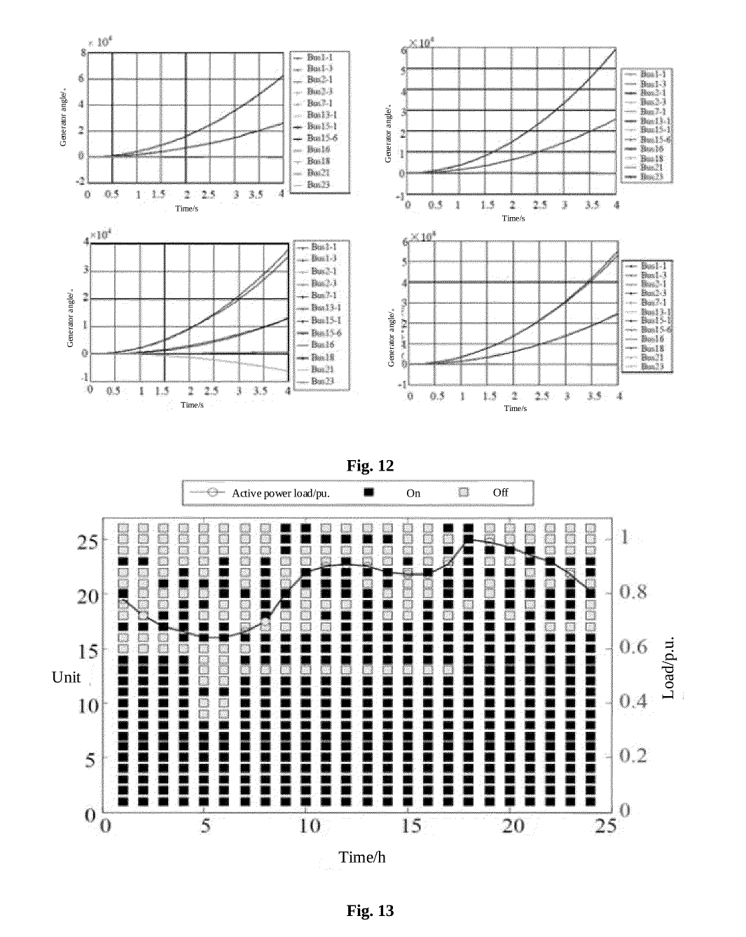

For validating the dynamic security region in dealing with transient stability constraints, the operation states of the system are selected randomly for transient simulation, and the results are shown in FIG. 12.

The results show that the optimal solution of Model I does not satisfy the transient stability constraints, the static voltage stability margin is low, and there are overload branches at the peak load period. The dispatch scheme of Model I is best in the economy aspect of power system, but it does not satisfy the network security constraints.

Model II

On/Off State and Active Power Output of Units

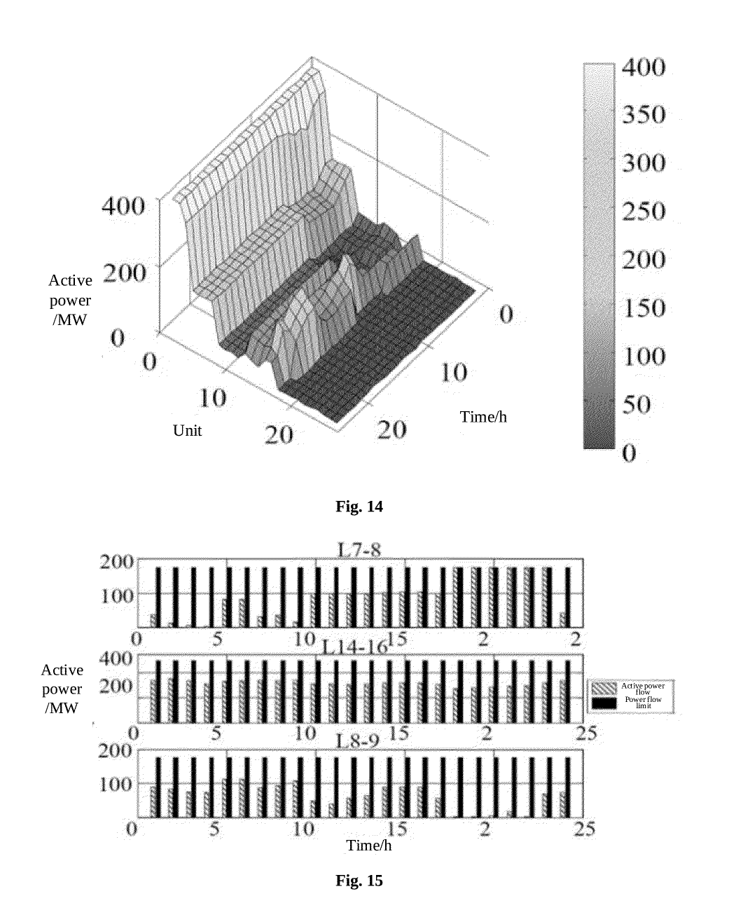

The optimal on/off scheme of units acquired by Model II is shown in FIG. 13, and active power output of units is shown in FIG. 14.

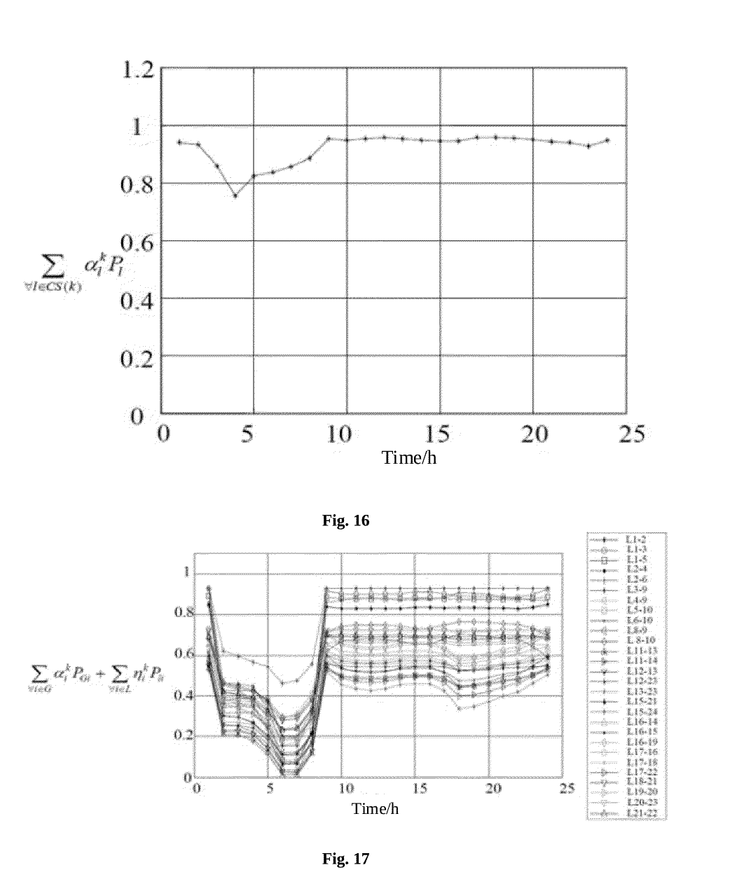

Operating network security constraints to the economic dispatching method of Model II, the results are shown in FIGS. 5, 16 and 17.

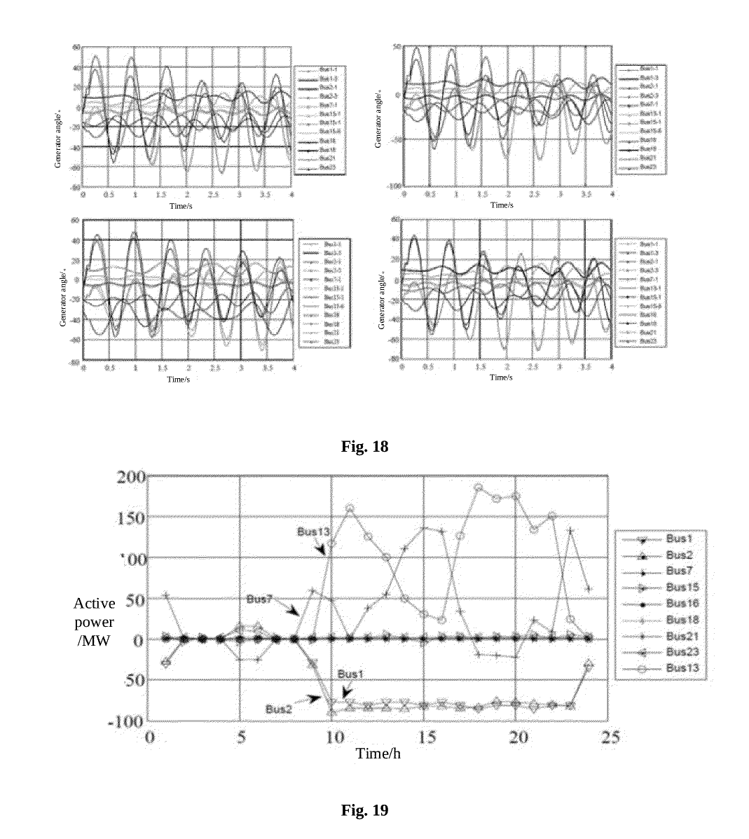

Select several operating points randomly to perform transient stability simulations, the results are shown in FIG. 18. The results show that the optimal solution of Model II satisfies the branches power flow constraints, the static voltage stability constraints and the transient stability constraints for the whole dispatch horizon.

Comparison between Model I and Model II:

The total generation cost of optimal solution for Model II is 731838.79$, larger than that of Model I (715799.89$). The differences of active power output between Model I and II are shown in FIG. 19. If unit i increases its active power output in Model II, then the value is positive, otherwise the value is negative.

FIG. 19 shows that, compared with Model I, part of load for bus 1 and bus 2 is transferred to bus 7 and bus 13 in the optimal solution for Model II for satisfying the transient stability constraints.

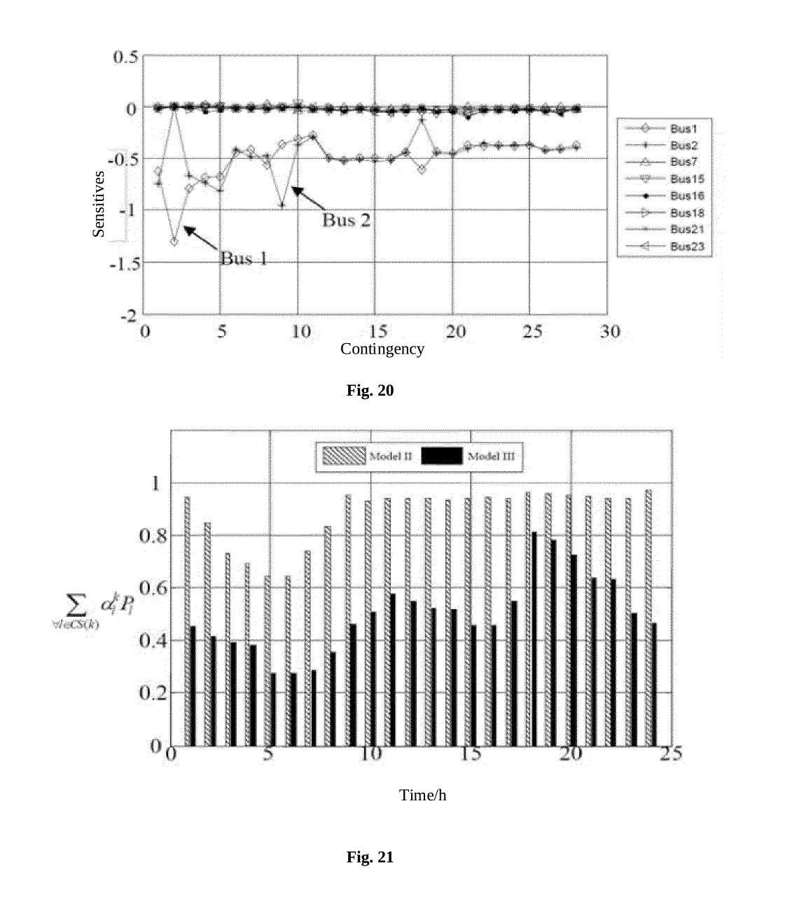

The sensitivities of transient stability margin to bus power injection are shown in FIG. 20. It shows that the sensitivities of transient stability margin to power injection for bus 1 and bus 2 are negative, which means that the increase of active power outputs for bus 1 and bus 2 is detrimental to the transient stability of power system. So, in Model II, the active power outputs of bus 1 and bus 2 are decreased. And the conclusions are in accordance with that of FIG. 19.

Model III

The comparison of static voltage stability margin for optimal solutions of Model II and III is shown in FIG. 21.

Seen from the figures, the static voltage stability margin is significantly improved in Model III. And the total cost of optimal solution for Model III is $821120.01 which is larger than that of Model II.

Model IV

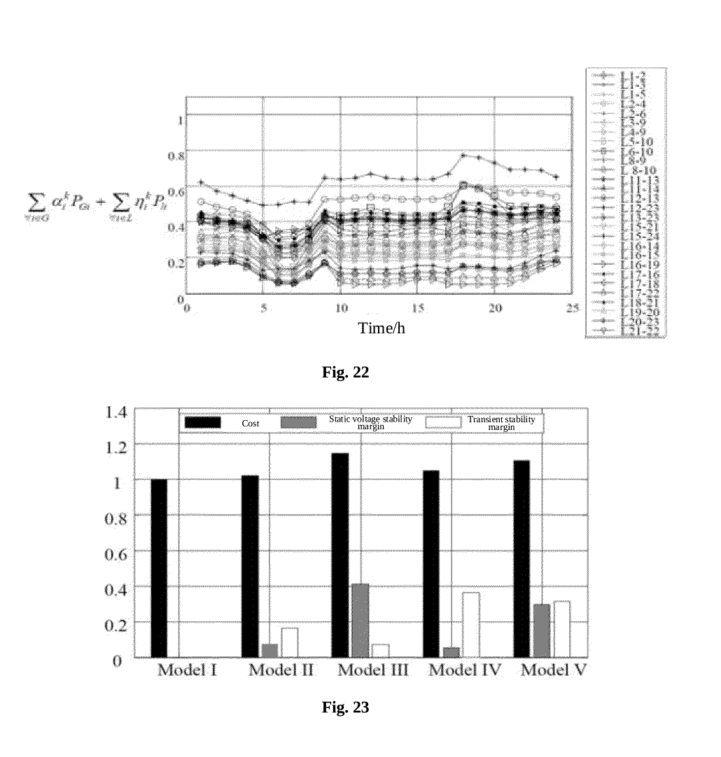

The transient stability of the optimal dispatching scheme for Model IV is shown in FIG. 22.

Compared with FIG. 17 and FIG. 22, the transient stability of the optimal dispatching scheme for Model IV is better than that of Model II and the cost of the optimal dispatching scheme for Model IV ($753376.94) is higher than that of Model II.

Model V

The comparison of optimal solutions for Model I, II, III, IV and V is shown in FIG. 23.

Seen from the figure, generation cost (after normalization)is: Model I<Model II<Model IV<Model V<Model III; static voltage stability margin: Model III>Model V>Model II>Model IV; transient stability margin: Model IV>Model V>Model II>Model III. And the economics and the security aspects of power system reach a balance in Model V.

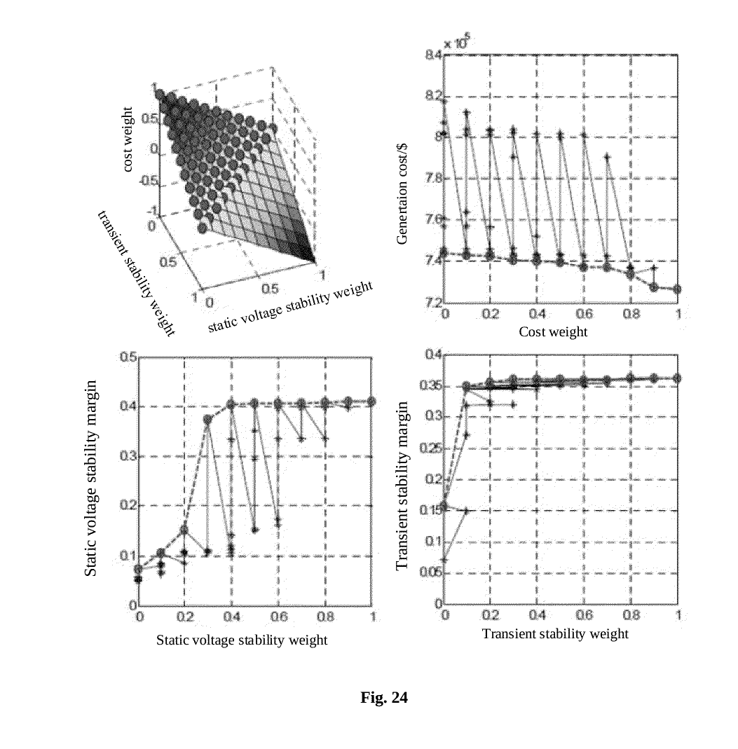

The influences of weights of objectives on results are shown in FIG. 24.

As shown in the FIG. 24, the preference of different optimization goals can be effectively adjusted by the weighting factors, and the corresponding goal trend to be optimal with the increase of the weighting factor(as shown by the dotted line). And for a given weighting factor, the result is influenced by other weighting factors.

Yixin Yu. Review of study on methodology of security regions of power system[J]. Journal of TianJin University, 2008, 41(6): 635-646. (in Chinese)

Yu Yixin, Feng Fei. Active power steady state security region of power system[J]. Science in China: Series A, 1990, 33(12): 1488-1500.

Qi Han, Yixin Yu, Huiling Li, et al. A practical boundary expression of static voltage stability region in injection space of power systems[J]. Proceedings of the CSEE, 2005, 25(5): 8-14. (in Chinese)

Huiling Li, Yixin Yu, Qi Han, et al. Practical boundary of static voltage stability region in cut-set power space of power systems[J]. Automation of Electric Power Systems, 2005, 29(4): 18-23. (in Chinese).

Fei Feng, Yixin Yu. Dynamic security regions of power systems in injection spaces[J]. Proceedings of the CSEE, 1993, 13(3): 14-22. (in Chinese)

Yuan Zeng, Yixin Yu, Hongjie Jia, et al. Computation of dynamic security region based on active power perturbation analysis[J]. Automation of Electric Power Systems, 2006, 30(20): 5-9. (in Chinese)

Yu Yixin, Zhang Hongpeng. A social cognition model applied to general combination optimization problem[C]. Proceedings of the first international conference on machine learning and cybernetics, Nov. 4-5, 2002 Beijing China: 1208-1213.

Zhe Wang, Yixin Yu, Hongpeng Zhang. Social evolutionary programming based unit commitment[J]. Proceedings of the CSEE, 2004, 24(4): 12-17. (in Chinese)

Yuda Hu. Practical models and optimization methods for multi-objective optimization problems[M]. Shanghai: Shanghai Science and Technology Press, 2010: 81-100.

P. M. Subcommittee. IEEE reliability test system[J]. IEEE Transactions on Power Apparatus and Systems, 1979, 98(6): 2047-2054.

What is claimed is:

1. A security region based security-constrained economic dispatching method, which comprises the following steps:
Step 1: presetting parameter, network system topology parameter, cut-sets for the static voltage stability, contingency sets for the transient stability and power flow limit value for branches, calculating the coefficients for the active power static security region, the cut-set voltage stability region and the dynamic security region;
Step 2: building the models for security region based security-constrained economic dispatch, which can be divided into the following models according to the optimization goals: (1) model I, which takes the minimum total generation cost as its optimization goal, and the constraint conditions comprises the operating constraints of units, system power balance and spinning reserve constraints; (2) model II, which takes the minimum total generation cost as its optimization goal, and the constraint conditions comprises the operating constraints of units, system power balance and spinning reserve constraints, and network security constraints; (3) model III, which takes the maximum static voltage stability margin as its optimization goal, and the constraint conditions of which are same as that of model II; (4) model IV, taking the maximum transient stability margin as its optimization goal, and the constraint conditions of which are same as that of model II; (5) model V, which transforms the minimum total generation cost, the maximum static voltage stability margin and the maximum transient stability margin into a single optimization goal via the weighting method, and the constraint conditions of which are same as that of model II; The model is divided into on/off state optimal sub-problem and load economic dispatching sub-problem to be solved;
Step 3: solving the unit on/off state optimal sub-problem through social evolutionary Programming, obtaining the optimal on/off states of unit for the dispatching period, calculating the start-up cost of units for the dispatch period, and achieving the actual upper and lower limit values for active power output for units with considering the ramp rate constraints of units;
Step 4: taking the on/off states and limit values for active power output of units as the input values, and solving the load economic dispatch sub-problem according to the optimization goal, i.e., optimal dispatching the active power output of units and calculating the generation cost, static voltage stability margin and the transient stability margin of units;
Step 5: obtaining a feasible economic dispatching scheme through step 3 and step 4, and determining whether it satisfies the convergence condition: if yes, then stop; otherwise, return to step 3.

2. The security region based security-constrained economic dispatching method of claim 1, wherein the objective functions of models in the step 2 are as follows:
(1) variables definition
The variables used in the invention are defined as follows:
TC: Total generation cost of the system, including the start-up cost and generation cost of units;
T: time number of scheduling period;
G: Set of generator buses of the system;
Gₛ: Set of units of the system, a generator bus may connects to a plurality of generators;
L: Set of load buses of the system;
B: Set of branches of the system;
N: Set of buses of the system, N=G∪L∪0, while 0 is the swing bus, the complex voltage of which is preset as the reference for the grid;
n: number of buses of the system; n=n_{G}+n_{L}+1
n_{g}: number of generators of the system;
n_{G}: number of generator buses of the system;
n_{L}: number of load buses of the system;
n_{B}: number of branches of the system;
wₜ: load weight of the period t;
w_{c}: cost weight of the period t;
wₛᵥ: Static voltage stability margin weight;
wₜₛ: transient stability margin weight;
Sᵢ(t): binary variable to indicate the state of generator i at period t; 0 represents the generator is off, while 1 represents on;
SCᵢ(t): start-up cost of unit i at period t;
Cᵢ(t): generation cost of unit i at period t;
C(t): total generation cost of the system at period t;
\tilde{C}(t): normalized value of the total generation cost of the system at period t;
P_{gi}(t): active power output of unit i at period t;
p_{gi}^{m}: minimum active power output of unit i;
p_{gi}^{M}: maximum active power output of unit i;
Pₗ^{M} : maximum active power flow of branch l allowed to transmit;
Xᵢ(t): Integer variable to indicate the cumulative operating state of unit i at period t; if
Xᵢ(t)>0, it means that unit i is on before period t; otherwise, it means that unit i is off before period t;
Tᵢ^{off}: minimum continuous off-time of unit i;
Tᵢ^{on}: minimum continuous on-time of unit i;
Δpᵢ^{u}: maximum ramp-up ramp rate of unit i;
Δpᵢ^{d}: maximum shut-down ramp rate of unit i;
P_{gi}(t): active power output of bus i at period t;
P_{di}(t): active load of bus i at period t;
D(t): system total load at period t;
R(t): system allowed minimum spinning reserve capacity at period t;
Vᵢ: voltage amplitude of bus i;
θᵢ: voltage angle of bus i;
Gᵢⱼ: the conductance between bus i and bus j;
Bᵢⱼ: the susceptance between bus i and bus j;
Pᵢ(t): active power flow of branch at period t;
CS: set of critical cut-sets for voltage stability, while CS(k) is Set of branches for cut-set k;
CTS: set of contingency for transient stability;
αᵢ^{k}: dynamic security region hyperplane coefficient of bus i for contingency k;
αₗ^{k}: cut-set voltage stability region hyperplane coefficient of branch for the cut-set k;
KD: matrix to indicate the cumulative operating states of units; if KD(t,i)>0, it means that unit i is on before period t; otherwise, it means that unit i is off before period t;
KJ: matrix to indicate on/off permission flags of units; KJ(t, i) represents on/off flag of unit i at period t, if KJ(t,i)=1, it means that unit i can be turned on at period t; if KJ(t,i)=−1, it means that unit i can be turned off at period t; if KJ(t,i)=0, it means that unit i must keep its operating state;
KR: matrix to indicate operating states of units; if KR(t,i)=1, it means that unit i is on at period t; if KR(t,i)=0, it means that unit i is off at period t;
(2) Objective Function
(2.1) Model I & II
The objective function of Model I and II is shown in equation (1):
$$min TC = {\sum }_{t = 1}^{T} {\sum }_{i = 1}^{{n}_{g}} {S}_{i} ( t ) ( 1 - {S}_{i} ( t - 1 ) ) {SC}_{i} ( t ) + {\sum }_{t = 1}^{T} {\sum }_{i = 1}^{{n}_{g}} {S}_{i} ( t ) {C}_{i} ( t ) \qquad ( 1 )$$
wherein, the start-up costs of units i is the function of the off-time of units as shown in equation (2), and the generation costs of units i can be approximated by a quadratic function, which is shown in equation (3); αᵢ, βᵢ and τᵢ are the coefficients of the start-up cost for i^{th} unit, aᵢ, bᵢ and cᵢ are the coefficients of the generation cost for the i^{th} unit, p_{gi}(t) is the active power output of units i;
SCᵢ(t)=αᵢ, +βᵢ(1−exp(Xᵢ(t)/τᵢ)) (2)
Cᵢ(t)=aᵢp_{gi}²(t)+bᵢp_{gi}(t)+cᵢ (3)
with the same objective function, the difference between Model I and Model II is: through the hyper-plane descriptive approach for security region, Model II designs the power flow constraint of branches, the static voltage stability constraint and the transient stability constraint on the basis of Model I;
(2.2) Model III
Model III is oriented to maximize the static voltage stability margin of power system and takes the operating constraints of units, the system power balance and spinning reserve constraints and the network security constraints into consideration for dispatching the system; the static voltage stability margin is defined as the distance from the current operating point and the boundary of CVSR, which is shown in equation (4); as there exists more than one critical cut-set for the static voltage stability, the minimum distance from the operating point to the boundaries of CVSR for all critical cut-sets is taken as the static voltage stability margin, shown in equation (5); wherein, ηₛᵥ^{k}(t) is the distance from the current operating point to the corresponding cut-set voltage boundary of the k^{th} critical cut-set at period t, and can be used as the approximate description of the static voltage stability margin of the current operating point for the k^{th} critical cut-set;
$$\begin{matrix}{η}_{sv} ( t ) = 1 - {\sum }_{l ∈ CS} {α}_{l} {P}_{l} ( t ) & ( 4 ) \\ {η}_{sv} ( t ) = {min}_{k} {η}_{sv}^{k} ( t ) = {min}_{k} ( 1 - {\sum }_{l ∈ CS ( k )} {α}_{l}^{k} {P}_{l} ( t ) ) & ( 5 )\end{matrix}$$
For the whole dispatching horizon, static voltage stability margins of different periods are multiplied by the load-level weight, and forming the objective function as shown in equation (6), the load-level weight can be calculated through (7);
$$\begin{matrix}max {η}_{sv} = max min {\sum }_{t = 1}^{T} {w}_{t} {η}_{sv}^{k} ( t ) & ( 6 ) \\ {w}_{t} = D ( t ) / {\sum }_{t = 1}^{T} D ( t ) & ( 7 )\end{matrix}$$
(2.3) Model IV
The transient stability margin is defined as the distance from the current operating point to the boundary of dynamic security region, as shown in equation (8);
$${η}_{ts} ( t ) = 1 - {\sum }_{i ∈ G ⋃ L} {α}_{i} {P}_{i} ( t ) \qquad ( 8 )$$
assuming that the predictive contingency comprising more than one fault, the minimum distance from the current operating point to the boundaries of dynamic security region for all faults is taken as the transient stability margin, as shown in equation (9); wherein, ηₜₛ^{k}(t) is the distance from the current operating point to the boundary of dynamic security region for the k^{th} contingency, and can be used as the approximate description of the transient stability margin of the current operating point for the k^{th} contingency;
$${η}_{ts} ( t ) = {min}_{k ∈ CTS} {η}_{ts}^{k} ( t ) = {min}_{k ∈ CTS} ( 1 - {\sum }_{i ∈ G ⋃ L} {α}_{i}^{k} {P}_{i} ( t ) ) \qquad ( 9 )$$
similar to Model III, for the whole dispatching horizon, transient stability margins of different periods are multiplied by the load-level weights, forming the objective function (10) of Model IV:
$$max {η}_{ts} = max min {\sum }_{t = 1}^{T} {w}_{t} {η}_{ts}^{k} ( t ) \qquad ( 10 )$$
(2.4) Model V
for solving the incommensurability, the normalization of objective function is adopted as shown in equation (11), and the evaluation function method is also adopted for transforming the multi-objective programming problem into a single objective programming problem, wherein the equation (11):
$$\tilde{C} ( t ) = 2 - \frac{C ( t )}{{C}_{0} ( t )} \qquad ( 11 )$$
through the normalization, the value of normalized value ranges from 0 to 1; and through the weighting method, Model V can be transformed into a single-objective optimization problem as shown in equation (12).
$$max ϕ = max {\sum }_{t = 1}^{T} {w}_{t} ( {w}_{c} \tilde{C} ( t ) + {w}_{sv} {η}_{sv} ( t ) + {w}_{ts} {η}_{ts} ( t ) ) \qquad ( 12 )$$

3. The security region based security-constrained economic dispatching method of claim 1, wherein the constraints comprises: the operating constraints of units, the system constraints (including power balance constraint and spinning reserve constraint) and the network security constraints;
(3.1) operating constraints of units
the operating constraints of units include the active power output constraint, the minimum continuous on/off time constraint and the ramp rate constraint, wherein:
active power output constraint:
p_{gi}^{m}≦p_{gi}(t)≦p_{gi}^{M} (13)
Ramp rate constraint:
−Δpᵢ^{d}≦p_{gi}(t)−_{gi}(t−1)≦Δpᵢ^{u} (14)
Minimum continuous on/off time constraint:
$$\{ \begin{matrix}if & {S}_{i} ( t ) - {S}_{i} ( t - 1 ) = 1 & then & - {X}_{i} ( t ) \geq {T}_{i}^{off} \\ if & {S}_{i} ( t ) - {S}_{i} ( t - 1 ) = - 1 & then & {X}_{i} ( t ) \geq {T}_{i}^{on}\end{matrix} \qquad ( 15 )$$
(3.2) Power Balance and Spinning Reserve Constraints
Power balance constraint:
$${\sum }_{i = 1}^{{n}_{g}} {S}_{i} ( t ) {p}_{gi} ( t ) = D ( t ) \qquad ( 16 )$$
Spinning reserve constraint:
$${\sum }_{i = 1}^{{n}_{g}} {S}_{i} ( t ) {p}_{gi}^{M} \geq D ( t ) + R ( t ) \qquad ( 17 )$$
(3.3) Network Security Constraints
the network security constraints include the branch power flow constraint, the static voltage stability constraint and the transient stability constraint, wherein:
branches power flow constraint
−Pₗ^{M}≦Pₗ(t)≦Pₗ^{M} l∈B (18)
static voltage stability constraint
$${\sum }_{∀ l ∈ CS ( k )} {α}_{l}^{k} {P}_{l} ( t ) \leq 1 , k ∈ CS \qquad ( 19 )$$
transient stability constraint
$${\sum }_{∀ i ∈ G ⋃ L} {α}_{i}^{k} {P}_{i} ( t ) \leq 1 , k ∈ CTS \qquad ( 20 )$$

4. The security region based security-constrained economic dispatching method of claim 1, wherein the method adopts social evolutionary programming for solving the unit on/off state schedule sub-problem, and the basic idea is: to the UC problem, several cognitive rules are defined to guide the agents to study and update with each other;
the optimization process of cognitive agents comprises:
\textcircled{1} Inputting the base data for UC, and sorting all the units according to the average cost of maximum active power output hrᵢ=aᵢp_{gi}^{M}+bᵢ+cᵢ/p_{gi}^{M} in ascending order;
\textcircled{2} According to KD(t, i), judging whether units satisfy the minimum continuous on/off time constraint and determining KJ(t,i) (i=1, 2, . . . , N);
\textcircled{3} Selecting one or several units in the set of units which satisfies KJ(t,i)≠0,i=1,2, . . . N and can change the state of those units, thus forming a new dispatch scheme, then judging whether the new dispatch scheme satisfies the load and spinning reserve constraints, if yes, then go to step \textcircled{4}, otherwise repeat \textcircled{3};
\textcircled{4} achieving KR(t,i), (i=1, 2, . . . , N);
\textcircled{5} if t=T, stopping; if t<T, determining KR(t+1, i) according to KR(t, i), and return \textcircled{2};
The rules for agents to inherit and update a paradigm are as follows: For the dispatching period t, the agent selects a paradigm Dₛ^{k} through Roulette Selection Method; Ωₖₒₙ^{t} is the set of units that can be turned on at period t in Dₛ^{k} while Ω_{koff}^{t} is the set of units that can be turned off. And Ω_{con}^{t} is the set of units that can be turned off; when determining KR(t,i), the agent will select units of a lower hr in Ω_{con}^{t}∩Ωₖₒₙ^{t} to turn on and units of a higher hr in Ω_{coff}^{t}∩Ω_{koff}^{t} to turn off; if Ω_{con}^{t}∩Ωₖₒₙ^{t}=φ or Ω_{coff} ^{t}∩Ω_{koff}^{t}=φ(φis null set), the agent will random select units in Ω_{con}^{t} or Ω_{coff}^{t} to transform their states.

5. The security region based security-constrained economic dispatching method of claim 1, wherein the following assumptions are proposed for solving the load economic dispatching sub-problem:
1) for the transmission system of high voltage, the impedance of transmission lines are far more than the resistance, so it is assumed that G >>0, neglecting conductance of transmission line;
2) under the steady-state operating conditions, the branch angle qᵢⱼ is very small, so there exists such approximation relation of sin θᵢⱼ≈θ_{ij;}cos θᵢⱼ≈1;
3) as the economic dispatch of active power is concerned in power system, assuming Vᵢ>>1, neglecting the influence of reactive power;
under the above assumptions, the power flow function of power system can be transformed into
$${P}_{gi} ( t ) - {P}_{di} ( t ) = {\sum }_{j ∈ i} {B}_{ij} {θ}_{ij} ( t ) i ∈ N \qquad ( 21 )$$
Further, equation (21) can be expressed as θᵢ(t)=XP(t), wherein X=B⁻¹=[x₀, x₁, . . . , xₙ]^{T};
$$\begin{matrix}{P}_{l} ( t ) = {P}_{ij} ( t ) = \frac{{V}_{i} {V}_{j}}{{x}_{ij}} sin {θ}_{ij} ( t ) \\ \approx \frac{{θ}_{ij} ( t )}{{x}_{ij}} = {K}_{l}^{T} P ( t )\end{matrix} \qquad ( 22 )$$
Wherein, Kₗ^{T}=−Bᵢⱼ(xᵢⱼ−xⱼ);
so the static voltage stability constraint can be transformed into the bus power injection space, shown in equation (23);
$${\sum }_{∀ l ∈ CS ( k )} {α}_{l}^{k} {K}_{l}^{T} P ( t ) \leq 1 , k ∈ CS \qquad ( 23 )$$
to assure the spinning reserve constraint for next period, a constraint shown in equation (24) is considered in the second sub-problem:
$${\sum }_{i = 1}^{{n}_{g}} min ( {p}_{gi} ( t ) + Δ {p}_{i}^{u} , {p}_{gi}^{M} ) \geq D ( t + 1 ) + R ( t + 1 ) \qquad ( 24 )$$
according to the different objective functions, the load economic dispatching Sub-problem may be transformed as a quadratic programming model in Model I & II, max-min programming model in Model III & IV or multiple-objectives programming model in Model V.
